(19) United States
(12) Patent Application Publication
(10) Pub. No.: US 2025/0357502 A1
(43) Pub. Date: Nov. 20, 2025

(54) HIGH TEMPERATURE METAL COMPOSITE BIPOLAR PLATES

(71) Applicant: ZEROAVIA LTD, Cirencester (GB)

(72) Inventors: Sergei Shubenkov, Cirencester (GB); Viktor Belousov, Cirencester (GB); Aleksandar Vasilev Todorov, Cirencester (GB)

(21) Appl. No.: 19/279,870

(22) Filed: Jul. 24, 2025

Related U.S. Application Data
(62) Division of application No. PCT/US2024/010551, filed on Jan. 5, 2024.

(30) Foreign Application Priority Data
Jan. 24, 2023 (GB) 2301023.4
Jan. 27, 2023 (GB) 2301242.0
Mar. 15, 2023 (GB) 2303807.8
Mar. 15, 2023 (GB) 2303812.8

(51) Int. Cl. H01M 8/0228; H01M 8/0208; H01M 8/0221; H01M 8/0258

(52) U.S. Cl. CPC H01M 8/0228; H01M 8/0208; H01M 8/0221; H01M 8/0258; H01M 2250/20

(57) ABSTRACT

A High Temperature Proton Exchange Membrane (HT-PEM) fuel cell includes a Proton Exchange Membrane (PEM); an anode catalyst layer on one surface of the PEM, and a cathode catalyst layer on the opposite surface of the PEM; Gas Diffusion Layers (GDLs) on outside surfaces of the anode and the cathode layers; and Bipolar Plates (BPPs) on outside surfaces of the GDLs. One or more contacting surfaces of the Membrane Exchange Assembly (MEA) subcomponents are coated, at least in part, with an electrically conductive polymer composite material that softens at or below the operating temperature of the HT-PEM. Also disclosed is a fuel cell bipolar plate (BPP) that includes a plurality of gaseous media coolant flow channels which have deflection barriers configured to cause the gaseous media coolant to divide and flow horizontally around a deflection barrier in a direction of an adjacent gaseous media coolant flow channel.

### CROSS REFERENCE TO RELATED APPLICATIONS

This application is a divisional of PCT Patent Application No. PCT/US2024/010551, filed Jan. 5, 2024, which claims priority to UK Patent Application No. 2301023.4, filed Jan. 24, 2023, now UK U.S. Pat. No. 2,614,450, UK Patent Application No. 2301242.0, filed Jan. 27, 2023, now UK U.S. Pat. No. 2,619,577, UK Patent Application No. 2303807.8, filed Mar. 15, 2023, and UK Patent Application No. 2303812.8, filed Mar. 15, 2023, the contents of which are incorporated herein by reference.

### TECHNICAL FIELD

The present disclosure relates to corrosion-resistant, electrically-conductive elements and methods for making the same. The disclosure has particular utility to the creation of corrosion-resistant, electrically-conductive elements for use as bipolar plates in Proton Exchange Membrane (PEM) fuel cells including, in particular, High Temperature Proton Exchange Membrane (HT-PEM) fuel cells for use in fuel cell powered vehicles, including aircraft, and will be described in connection with said utility, although other utilities are contemplated including, by way of example, formation of batteries and other electronic device.

### BACKGROUND AND SUMMARY

This section provides background information related to the present disclosure which is not necessarily prior art. This section provides a general summary of the disclosure and is not a comprehensive disclosure of its full scope or all its features.

A fuel cell is an electrochemical device that converts chemical energy produced by a reaction directly into electrical energy. A typical hydrogen fuel cell includes a PEM, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with hydrogen protons to form water. The anodic and cathodic reactions are described by the following equations:

H₂→2H⁺+2e⁻at the anode of the cell, and Equation 1

O₂+4H⁺+4e⁻→2H₂O at the cathode of the cell. Equation 2

PEM fuel cells are made from several layers of different materials. The heart of a PEM fuel cell is the membrane electrode assembly (MEA), which includes a PEM membrane, catalyst layers, and gas diffusion layers (GDLs).

FIG. 1 is a perspective view and FIG. 1a is an exploded view which together illustrate a conventional PEM fuel cell 510. Fuel cell 510 includes a PEM 512, typically formed in a specially treated polymer material that conducts only positive charged ions, and blocks electrodes.

Catalyst layers are provided on both sides of the PEM 512—an anode catalyst layer 514 on one side, and a cathode catalyst layer 516 on the other. GDLs 518, 520 sit to the outside of the catalyst layers 514, 516 and facilitate transport of reactants into the catalyst layers, as well as removal of the product water. The PEM 512, catalyst layers 514, 516 and the GDLs 518, 520 together make up the so-called MEA 522. The MEA 522 is the part of the fuel cell where power is produced.

Each individual MEA 522 produces less than one volt under typical operating condition, but most applications require higher voltages. Therefore, multiple MEAs 522 usually are connected in series by stacking them on top of one other to provide a usable output voltage. Each cell in the stack is sandwiched between two graphite bipolar plates (BPPs) 524, 526 to separate it from neighboring cells. These plates 524, 526, which may be made of metal, carbon, or composites, provide electrical conduction between cells, as well as providing physical strength to the stack. The surfaces of the plates typically contain channels 528, 530 machined or stamped into the plates 524, 526 to allow gases to flow over the MEA 522. Such flow channels are provided to distribute reactants over an active area of the fuel cell thereby maximizing performance and stability. Additional channels (not shown) inside each plate 524, 526 may be used to circulate a liquid coolant.

Each MEA 522 in a fuel cell stack is sandwiched between two graphite bipolar plates 524, 526, and gaskets 536, 538 are added around the edges of the MEA 522 to make a gas-tight seal. These gaskets usually are made of a rubbery polymer. Each fuel cell 510 includes current collectors 540, 542 and end plates 544, 546.

Referring also to FIG. 3, typically reactant flow channels 528, 530 on the one hand and coolant flow channels 532, 534 on the other hand are formed to run essentially parallel to one another, and reactant flow channels 528, 530 on the one hand and coolant flow channels 532, 534 on the other hand are formed to run traverse to each other, typically essentially perpendicular to each other as illustrated in FIG. 3.

Summarizing to this point, fuel cell systems, particularly for surface-based applications, typically have BPPs to provide both working gases and coolant liquid flowing through separate channels. However, the high volumetric density of coolant liquid is problematic for applications such as aircraft. Air-cooling is a more lightweight method but its low density, high thermal conductivity, and low thermal capacity pose challenges to cooling efficiency. Current state-of-art air-cooled BPPs typically are formed by sheet-metal into simple rectangular or linear flow field patterns with thick and shallow channels which lead to inlet overcooling and outlet undercooling. Alternatively, the anode plate may be formed of metal and the cathode plate formed of a polymeric composite material according to Applicant's internal prior art as disclosed in PCT Application Serial Nos. PCT/US2022/025162 and PCT/US2022/028976, and Applicant's co-pending UK Patent Application No. GB2303807.8, filed 15 Mar. 2023 (Attorney Docket CI-ZERO 23.05 UK), the contents of which are incorporated herein in its entirety by reference. Since air is not able to evenly remove enough heat from the aluminum BPP, the resulting temperature gradient across a single plate can be up to 35° C. Additionally, for aviation, required power output and hence cooling parameters vary at different stages of flight (e.g., an aircraft in cruise may typically use 30% of takeoff/initial climb power). Thus, there is a need to ensure sufficient and even cooling with air throughout different stages of flight and for different aircraft types.

There are two types of PEM fuel cells, so-called Low Temperature Proton Exchange Membrane (LT-PEM) fuel cells which must be operated with hydrogen of high purity, typically more than about 99.9%, and High Temperature Proton Exchange Membrane (HT-PEM) fucl cells which are far less sensitive to impurities and may be operated with reformate gas with hydrogen concentrations of 50-75%. In contrast to LT-PEM fuel cells which are sensitive to carbon monoxide concentrations of as little as several parts per million, HT-PEM fuel cells may be operated at hydrogen monoxide concentrations of up to 3 vol. %. Thus, HT-PEM fuel cells offer advantages over LT-PEM fuel cells in terms of fuel costs. However, HT-PEM fuel cells typically are operated at temperatures of 150 to 180° C., which creates thermal management challenges, and typically employ highly corrosive phosphoric acid as an electrolyte, which traditionally has limited the materials that can be used for forming the bipolar plates elements for HT-PEM fuel cells to high temperature and acid resistant materials such as polybenzimidazole (PBI). PBI-based PEMs must be loaded or doped with high amounts of phosphoric acid to function efficiently. However, PBI-based PEMs can only be doped in phosphoric acid at relatively low loadings before mechanical properties start to significantly diminish. Furthermore, the methods used to load PBI-based PEMs membranes with high amounts of phosphoric acid are relatively tedious, and include several steps which add to costs. However, HT-PEM fuel cells offer significant advantages over LT-PEM fuel cells in that their waste heat is a higher temperature and thus may be rejected with less cooling drag per unit of energy. Thus, there is a long felt need to make practical HT-PEM fuel cells with long lifetimes despite the adverse temperatures and acidic electrolyte.

Metals such as copper and nickel and their alloys as well as stainless steel have been proposed for use as materials for bipolar plates for HT-PEM fuel cells due to their mechanical properties, high electrical conductivity, low gas permeability high temperature resistance and relatively low cost of manufacture. However, such metals have problems in terms of the electrochemical processes that take place at their surface including: (1) formation of non-conductive surface oxides (corrosion) in HT-PEM fuel cell environments resulting in a high contact resistance which eventually lowers the efficiency of the PEM fuel cell system; and (2) the dissolution of metal cations from the metals and metal alloys and their subsequent contamination of the MEA (e.g., anode, separator and cathode assembly) which eventually may lead to system failure.

To solve the corrosion problem, a prior practice has been to coat the surface of metal bipolar plates with a material that forms a barrier to corrosion and at the same time will not diminish the advantageous properties of the metallic bipolar plate. Corrosion barrier coatings that have been used on metal plate surfaces include nitrides such as chromium nitride (CrN) and titanium nitride (TiN). However, high vacuum conditions and high temperatures (ca. 900° C.) required to ensure the formation of non-brittle phases of CrN needed for this approach limit its scale and therefore its cost-efficient manufacturability. In addition, the presence of metal ions from the barrier layer creates a potential for diffusive contamination through the barrier layer into the MEA.

Light weight metals such as aluminum, magnesium and titanium and their alloys also have been proposed for use in forming bipolar plates for HT-PEM fuel cells particularly for use in hydrogen fuel cell powered aircraft, where weight is a significant factor. Aluminum, magnesium, and titanium and their alloys are strong, lightweight materials and exhibit high heat conductivity making them excellent materials for heat removal. Such lightweight and thermally-conductive materials enable effective heat removal from the fuel cell stack and increased power output per kg. However, aluminum, magnesium and titanium and their alloys readily dissolve in phosphoric acid.

Previous attempts to create aluminum, magnesium and titanium based bipolar plates have focused on metal coatings or plating to passivate or protect the metal surfaces. However, these metallic coatings (such as Au, Ti nitrides, Ni, Sn, Re and oxides thereof) require a thick layer to prevent corrosion, resulting in expensive and heavy weight bipolar plates. The present disclosure in one aspect provides aluminum, magnesium, or titanium-based PEM plates with thin, lightweight highly protective, electrically conductive layers to improve the chemical compatibility of aluminum, magnesium and titanium bipolar plates within a HT-PEM operating environment.

Large scale applications of lightweight, HT-PEM fuel cells particularly for use in fuel cell powered vehicles including aircraft require bipolar plates (BPPs) that are i) highly thermally conductive, and ii) thin to improve heat rejection from the fuel cell stack without adding much weight. Metals such as aluminum, beryllium and magnesium and their alloys are excellent thermal conductors, but their application as a BPP material is limited due to their relatively low modulus and relatively low elongation at break, which is important in the mechanical stamping and milling processes typically employed for forming, i.e., patterning the plates.

Previous attempts to form BPPs with deep narrow channels by mechanical stamping and milling processes of metals such as aluminum, beryllium and magnesium had limited success due to poor elongation and poor hardness of such metals. Traditional ways to achieve a desired metal plate shape modification require etching which is costly and environmentally undesirable, while mechanical processors such as stamping or rolling are limited in an ability to achieve deep channel formation. Moreover, mechanical processes such as stamping and rolling create weak structural points, which could lead to cracks and deformations, and ultimately cell failure. Other metals that are well suited for deep, narrow channel patterning such as stainless steel is heavy and do not provide enough thermal conductivity.

Also, efficient operation of a fuel cell requires good mechanical and electrical contact between the subcomponent layers in the fuel cell stack to minimize ohmic resistance. Current HT-PEM fuel cell interlayer contact relies on compression to maintain sufficient contact between layers. However, there are fundamental limitations for interlayer contact based on compression alone. Additionally, over multiple temperature cycles during operation, the fuel cell structure risks irreversible compression set and thermal expansion stresses, leading to poor electrical contact and decreased power output. There is a long felt need to improve the electrical contact without relying solely on compression.

The present disclosure creates a bipolar plate that is lightweight, conductive, and robust to the phosphoric acid corrosive environment in HT-PEM fuel cells, which increases the operational lifetime of the fuel cell system and reduces system weight and volume resulting in a denser power system. Indeed, HT-PEM fuel cells built using bipolar plates in accordance with the present disclosure as will be described below achieve power densities of up to 3-4 kW/kg. Improved contact between layers in the fuel cell stack also maintains efficient and consistent operation.

In one aspect of the disclosure there is provided an electrically conductive, corrosion-resistant element for use as a bipolar plate in a HT-PEM fuel cell comprising an electrically conductive metal substrate coated with a corrosion-resistant nickel-containing layer including a metal selected from Group 7, Group 11 or Group 15 of the Periodic Table, and phosphorous; a layer containing an electrically conductive corrosion-resistant noble metal or precious metal formed on the nickel-containing layer; and at least one polymer composite material layer comprising a high glass transition temperature (T_{g}), preferably in the range of 170° C.-230° C., and chemically resistant polymeric material containing conductive carbon particles on the noble metal or precious metal containing layer.

In one aspect one electrically conductive, corrosion-resistant nickel-containing layer includes rhenium. Rhenium and its oxides have demonstrated corrosion resistance to phosphoric acid and improved electrical conductivity. In other embodiments, plated nickel alloys can be doped with rhenium to improve corrosion resistance. Phosphorus is also a critical component for improving the material corrosion resistance of nickel alloys and can be combined by electroless deposition with other metals including rhenium or tungsten to create a corrosion-resistant coating.

In still another aspect of the electrically conductive, corrosion-resistant element the electrically conductive corrosion-resistant metal or precious metal layer comprises a metal selected from the group consisting of gold, silver, platinum, palladium, iridium, osmium, rhodium, ruthenium, tungsten, titanium, zirconium, vanadium, niobium, tantalum and alloys and mixtures thereof.

In another aspect of the electrically conductive, corrosion-resistant element the conductive carbon particles in the high T_{g} and chemically resistant layer are selected from the group consisting of carbon black, graphitized carbon particles, amorphous carbon particles, carbon nanotubes, and graphene sheets, and mixtures thereof.

In still yet another aspect of the electrically conductive, corrosion-resistant element the polymeric composite material layer comprises one or more layers including a high T_{g} and chemically resistant polymeric material selected from the group consisting of polyvinylidene fluoride, a polysulfone polymer selected of the group consisting of polyphenylsulfone, polyethersulfone and mixtures thereof, a polyaniline, a polythiophene, a poly(pyrrole), a polybenzimidazole, a polyethersulfone, a fluorinated ethyl-polypropylene, a perfluoralkoxy, and mixtures thereof.

In a further aspect of the electrically conductive, corrosion-resistant element the polymeric composite material layer(s) comprise multiple layers including a layer formed of polyvinylidene fluoride containing carbon nanotubes and/or carbon black or a mixture thereof, and a layer formed of polyphenylsulfone or polyethersulfone or a mixture thereof, and carbon nanotubes and/or carbon black and mixtures thereof.

In a further aspect of the electrically conductive, corrosion-resistant element the conductive carbon particles comprise carbon black particles comprising up to 25 mass % of the polymeric composite material layer(s), and/or carbon nanotubes comprising up to 20 mass % of the polymeric composite material layer, and mixtures thereof.

In a further aspect of the electrically conductive, corrosion-resistant element the metal substrate comprises a metal selected from the group consisting of aluminum, magnesium, titanium, and an alloy thereof.

The present disclosure also provides a HT-PEM fuel cell, comprising: a bipolar plate, wherein the bipolar plate comprises an electrically conductive, corrosion-resistant element as described above, and including an electrically conductive metal substrate coated with a corrosion-resistant nickel-containing layer including a metal selected from Group 7, Group 11 or Group 15 of the Periodic Table, and phosphorous; a layer containing an electrically conductive corrosion-resistant noble metal or precious metal formed on the nickel-containing layer; and at least one polymer composite material layer comprising a high T_{g} and corrosion-resistant polymeric material containing conductive carbon particles on the noble metal or precious metal containing layer.

In yet a further aspect, the fuel cell is a HT-PEM hydrogen fuel cell including a phosphoric acid electrolyte.

The present disclosure also provides a fuel cell powered vehicle comprising a fuel cell as described above.

In yet another aspect of the disclosure, the metal substrate comprises aluminum, magnesium or titanium and an alloy thereof, the vehicle comprises an aircraft, and the fuel cell comprises an HT-PEM hydrogen fuel cell including a phosphoric acid electrolyte.

In another aspect, the nickel-containing layer also contains a metal selected from the group consisting of gold, tungsten, titanium, zirconium, vanadium, niobium and tantalum, and alloys thereof.

Preferably the polymeric composite material layer also includes one or a mixture of conductive polymers and/or chemically resistant polymers having a T_{g} of 170-230° C.

Preferably the conductive polymers are selected from the group consisting of a polythiophene, poly(3,4-cthylenedioxythiophene (PEDOT), a poly(pyrrole), a polyphenylsulfone (PPSU), and a polyaniline (PANI).

Preferably the high Te chemically resistant polymer is selected from the group consisting of polybenzimidazole (PBI), polyether ether ketone (PEEK), a thermoplastic polyimide (TPI), a polyethersulfone (PESU), a fluorinated ethylene-propylene (FEP), and a perfluoroalkoxy (PFA).

Preferably the electrically conductive substrate comprises a metal selected from the group consisting of copper, nickel and stainless steel.

According to another aspect of the present invention there is provided a fuel cell, comprising a bipolar plate, wherein the bipolar plate comprises the electrically conductive, corrosion-resistant element as set out as described above.

In another aspect of the present invention there is provided a fuel cell powered vehicle comprising a fuel cell as set as described above.

Preferably the vehicle comprises a fuel cell powered aircraft.

Preferably the fuel cell comprises a HT-PEM hydrogen fuel cell including a phosphoric acid electrolyte.

In accordance with another aspect of the present disclosure, we coat HT-PEM contacting subcomponent layers with a polymeric composite material that softens at or below the operating temperature of the fuel cell stack. More particularly we employ meltable, conductive polymer composite materials having a T_{g} and/or a melting temperature (Tm) lower than the fuel cell operating temperature to tether subcomponent layers of the fuel cell, i.e., the bipolar plates, the gas diffusion layers, the catalyst layers and/or the MEA.

More particularly, in accordance with the present disclosure, fuel cell electrical contact resistance between subcomponent layers of a fuel cell is reduced by coating subcomponent layers of a HT-PEM fuel cell with a material having a T_{g} and/or Tₘ lower than the fuel cell operating temperature. The coated fuel cell subcomponent layers are assembled, placed under load, and then thermal cycled above and below the T_{g} of the material. This process of cyclical heating under load creates an interpenetrated structure at the interface between fuel cell subcomponent layers.

Preferably the meltable conductive polymer composite material comprises polyvinylidene fluoride (PVDF) and a polysulfone polymer such as polyethersulfone (PESU). Polyvinylidene fluoride (PVDF (T_{g}=170C) promotes deformation and contact with neighboring surfaces, while polyethersulfone (PESU) T_{g}>225C creates an interconnected structure in the fuel cell stack during assembly. The compressed layer of PVDF softens in the fuel cell operating temperature range creating a patterned, wetted interface that mirrors any microstructure present on the neighboring component. PESU transfers microstructures or patterns present on mating surfaces of subcomponents into the melted PVDF layer during assembly.

PVDF also has an advantageous property of maintaining good, wetted contact between the subcomponent layers during fuel cell operation. PESU contributes to the formation of interconnected structures and helps to maintain the deformation of PVDF. PESU and PVDF enable reduction of contact resistance during assembly, while PVDF enables maintained reduction of contact resistance during operation. This construction can be used to reduce electrical resistance at the interface between the following subcomponent layers:
Bipolar Plate (BPP)
Membrane Electrode Assembly (MEA)
Gas Diffusion Layer (GDL)

In practice, fuel cell subcomponent layers (BPPs, GDLs and MEAs) are coated with a polymeric material having a T_{g} at or below the desired operating temperature range of the fuel cell. The coated composite fuel cell subcomponent layers (BPPs, GDLs, and MEAs) are first assembled by mechanically pressing the layers together at or above the polymer T_{g}. These layers deform essentially to match microstructures on the mating surface of fuel cell subcomponent layers, which improves interfacial contact and reduces contact resistance between the layers. The surfaces of the subcomponent layers also may be roughened, e.g., by microscale roughening so that the surface contact of the polymeric materials with the mating surface may be improved.

In other embodiments the subcomponent layers are pressed together by lamination, contact welding, tack welding, hot plate welding, or vacuum deposition under elevated temperatures.

While the MEA, GDL and BPP are described as the subcomponent layers bonded using this technique, the same method can be applied to other layers of the fuel cell where low electronic resistance is required, e.g., the PEM membrane and the catalyst layers.

In one embodiment of the disclosure the meltable conductive polymer composite is applied as a single layer of, e.g., 5-10 μm thickness composed of a conductive composite blend. In another embodiment the surface(s) of a subcomponent layer can be coated with multiple conductive polymer materials to create a multilayered structure. This can provide the additional benefit of stronger interlayer penetration and more controlled thermal and conformal behavior over a wider operating temperature range. For example, a three-layered structure may be created on a surface with one polymeric material having a T_{g} of 150° C., one with a T_{g} of 170° C., and one with a T_{g} of 220° C. This tailoring of material interconnect layers ensures that the benefits of contact between subcomponent layers are maintained across a wider operating temperature range.

Polymeric materials with a T_{g} ranging from 160°-250° C. may be applied to the BPPs, the GDLs, and the MEA by spray coating. Spray coating provides a more consistent coverage of polymeric layers. In other embodiments the polymeric layers can be applied using other application methods such as dipping, brush painting, blade coating, thermal spraying, plasma deposition, flow coating, spin coating, sol-gel, dip coating, powder coating, or surface grafting techniques.

The melt viscosity of the polymeric layer is an important property of the interconnected structure. Materials with similar melt viscosity values will create a more similar interconnected layer when the temperature is above the T_{g}. Materials with very low melt viscosity are more readily to coat the interfacial layer, which can lead to improved cross-contact between subcomponent layers. Materials should be selected with a melt viscosity that can maintain the desired layered thickness within the fuel cell operating temperature range.

The polymeric materials may be blended, filled, doped, or modified by addition of conductive particles to tune the electrical conductivity of the interface layer and can be used to further reduce contact resistance. By way of example but not limitation, the polymeric materials may be blended with carbon particles such as carbon black, carbon nanotubes, or graphene, metallic particles, or other conductive fillers to improve electrical contact at the interface. It is desired to have properties that approach the high conductivity of metal (i.e. gold) without the associated cost and weight of metals. Application may be in consistent and thin layers as a means to lower electrical contact resistance.

In still other embodiments polymeric materials with high T_{g} and chemical resistance can be used to add a deformable layer to fuel cell subcomponent layers, including: polyethersulfone (PESU) and polyphenylsulfone (PPSU), polyvinylidene fluoride (PVDF), polybenzimidazole (PBI), polyether ether ketone (PEEK), thermoplastic polyimide (TPI), polyethersulfone (PESU), Fluorinated ethylene-propylene (FEP), polyimide (PI), polyamide (PA), or perfluoroalkoxy (PFA), and polyphenyl sulfide (PPS).

In yet other embodiments, rigid, high melt flow index or high molecular weight polymeric materials can be added in a pattern to create a mechanical reinforcing structure to maintain spacing between compressed layers, similar to how rebar is used to reinforce concrete. This adds a benefit of strengthening a fuel cell to better survive a thermal runaway anomaly.

The material at the interconnect layer can further be modified by blending polymeric materials together to achieve the appropriate T_{g}, melt viscosity, and electrical conductivity. For example, PESU can be blended with PA and conductive fillers to maintain chemical resistance and mechanical compliance at interfaces.

The molecular weight (Mw) of the polymeric layer materials can be taken into consideration for forming interconnected structures. High Mw polymers may be blended with low Mw polymers to promote more polymeric entanglements at the interface, further improving interfacial contact. For example, PESU (M_{w}=45,000 g/mol) can be blended with PESU (M_{w}=8,000 g/mol) and applied as an interconnect layer.

The hysteresis behavior of the polymer interconnect material presents a challenge for maintaining device functionality over a long operating lifetime. Poor interfacial contact and material thickness variation due to thermal cycles or loss of loading is undesirable—this increases the contact resistance. Thus, the polymer contact materials may be selected for their ability to hold shape and maintain contact after repeated heat/cool cycles. And high T_{g} polymers can be modified with low T_{g} polymers to improve the material shape memory after heat cycles.

Interconnected polymer layers can be imprinted during the initial manufacturing step to control the shape of an interconnected layered structure. For example, polymeric interconnects may be applied to the surfaces of the BPPs, the MEA, and the GDLs. The structure could then be pressed at a temperature above the polymer interconnect material Te, held to create patterned deformations, then cooled in a controlled manner to ensure that interlayer contact is maintained. This manufacturing step can help to mitigate structural changes during operation.

Summarizing to this point, in one aspect of the disclosure we provide a HT-PEM fuel cell, comprising, from the inside: a MEA including the following subcomponents: a PEM; an anode catalyst layer on one outside surface of the PEM, and a cathode catalyst layer on opposite outside surface of the PEM; GDLs on outside surfaces of the anode and the cathode layers; and BPPs on outside surfaces of the GDLs; wherein one or more contacting surfaces of the MEA subcomponents are coated, at least in part, with an electrically conductive polymer composite material that softens at or below the operating temperature of the HT-PEM.

In one aspect of the disclosure, the HT-PEM fuel cell electrically conductive polymer composite material comprises a material having a glass transition T_{g} and melting temperature Tₘ below the operating temperature of the HT-PEM.

In another aspect of the disclosure the electrically conductive polymer composite material comprises a plurality of layers, each layer having a different T_{g} and Tₘ.

In yet another aspect of the disclosure the polymeric material has a T_{g} and Tₘ in the range of 160-250° C.

In a further aspect of the disclosure the conductive polymer composite material includes conductive carbon particles selected from the group consisting of carbon black, graphitized carbon particles, amorphous carbon particles, carbon nanotubes, graphene and a mixture thereof.

In yet another aspect of the disclosure the conductive polymer composite material includes metal particles selected from the group consisting of gold, tungsten, silver, titanium, zirconium, vanadium, niobium, tantalum, aluminum, magnesium, and an alloy thereof.

In a further aspect of the disclosure the conductive polymeric composite material layer comprises one or more layers including a layer formed of polyvinylidene fluoride, containing conductive particles, and a layer formed of a polysulfone polymer selected of the group consisting of polyphenylsulfone, polyethersulfone, and a mixture thereof, containing conductive particles.

In another aspect of the disclosure the polymeric composite material includes a polymeric material selected from the group consisting of polythiophene, poly(3,4-ethylenedioxythiophene (PEDOT), poly(pyrrole), polyphenylsulfone (PPSU), and polyaniline (PANI).

In a further aspect of the disclosure the conductive polymeric composite material includes a polymer material selected from the group consisting of polybenzimidazole, polyether ether ketone, thermoplastic polyimide, polyethersulfone, fluorinated ethylene-propylene, and perfluoroalkoxy.

In one aspect the polymeric composite material and the coating on the BPP surface have matched thermal expansion coefficients.

In another aspect, the polymeric composite material and the coating on the BPP surface have similar electrical conductivity properties.

The disclosure also provides a fuel cell powered vehicle comprising a HT-PEM fuel cell as described above.

In one aspect of the disclosure the vehicle comprises a HT-PEM fuel cell powered aircraft.

The disclosure also provides a method for maintaining electrical contact between subcomponents of a HT-PEM fuel cell, comprising coating at least in part a surface of at least some of the subcomponents with an electrically conductive polymer composite material that softens at or below an operating temperature of the HT-PEM.

The disclosure additionally provides a method of forming a HT-PEM fuel cell as above described, which comprises coating at least in part a surface of one or more of the subcomponents of a HT-PEM fuel cell with a conductive polymer composite material having a glass transition T_{g} and/or melting temperature Tₘ lower than the fuel cell operating temperature, pressing the subcomponents assembled together at a temperature above the T_{g} of the conductive polymer composite material, and subsequently cooling the assembled subcomponents while maintaining pressure on the assembled components.

In one aspect of the above method the fuel cell subcomponents are assembled, placed under pressure and thermal cycled above and below the T_{g} of the conductive polymer composite material.

In another aspect of the method the electrically conductive polymer composite material comprises a material having a glass transition T_{g} and melting temperature Tₘ below the operating temperature of the HT-PEM.

In still another aspect of the method the electrically conductive polymer composite material comprises a plurality of layers, each layer having a different T_{g} and Tₘ.

In yet another aspect of the method the polymeric material has a T_{g} and Tₘ in the range of 160-250° C.

In a further aspect of the method the conductive polymer composite material includes conductive carbon particles selected from the group consisting of carbon black, graphitized carbon particles, amorphous carbon particles, carbon nanotubes, graphene and a mixture thereof.

In yet another aspect of the method the conductive polymer composite material includes metal particles selected from the group consisting of gold, tungsten, silver, titanium, zirconium, vanadium, niobium, tantalum, aluminum, magnesium, and an alloy thereof.

In still yet another aspect of the disclosure the conductive polymeric composite material layer comprises one or more layers including a layer formed of polyvinylidene fluoride, containing conductive particles, and a layer formed of a polysulfone polymer selected of the group consisting of polyphenylsulfone, polyethersulfone, and a mixture thereof, containing conductive particles.

According to yet another aspect of the present invention there is provided a fuel cell powered vehicle comprising a HT-PEM fuel cell as above described.

Preferably the vehicle comprises a HT-PEM fuel cell powered aircraft.

According to a further aspect of the present invention there is provided a method for maintaining electrical contact between subcomponents of a HT-PEM fuel cell, comprising coating surface of at least some of the subcomponents at least in part with an electrically conductive polymer composite material that softens at or below an operating temperature of the HT-PEM.

According to another aspect of the present invention there is provided a method for maintaining electrical contact between subcomponents of a HT-PEM fuel cell according to aspect A of the present invention, comprising coating surface of at least some of the subcomponents at least in part with an electrically conductive polymer composite material that softens at or below an operating temperature of the HT-PEM.

According to yet another aspect of the present invention there is provided a method of forming a HT-PEM fuel cell as above described, which comprises coating at least in part a surface of one or more of the subcomponents with a conductive polymer composite material having a glass transition T_{g} and/or melting temperature Tₘ lower than the fuel cell operating temperature, pressing the subcomponents assembled together at a temperature above the T_{g} of the conductive polymer composite material, and subsequently cooling the assembled subcomponents while maintaining pressure on the assembled components.

Preferably the fuel cell subcomponents are assembled, placed under pressure and thermal cycled above and below the T_{g} of the conductive polymer composite material.

Preferably the electrically conductive polymer composite material comprises a material having a glass transition T_{g} and melting temperature Tₘ below the operating temperature of the HT-PEM.

Preferably the electrically conductive polymer composite material comprises a plurality of layers, each layer having a different T_{g} and Tₘ.

Preferably the polymeric material has a T_{g} and Tₘ in the range of 160-250° C.

Preferably the conductive polymer composite material includes conductive carbon particles selected from the group consisting of carbon black, graphitized carbon particles, amorphous carbon particles, carbon nanotubes, graphene and a mixture thereof.

Preferably the conductive polymer composite material includes metal particles selected from the group consisting of gold, tungsten, silver, titanium, zirconium, vanadium, niobium, tantalum, aluminum, magnesium, and an alloy thereof.

Preferably the conductive polymeric composite material layer comprises one or more layers including a layer formed of polyvinylidene fluoride, containing conductive particles, and a layer formed of a polysulfone polymer selected of the group consisting of polyphenylsulfone, polyethersulfone, and a mixture thereof, containing conductive particles.

While the foregoing disclosure describes primarily the use of thermoplastic polymers in forming the interconnect layers, thermoset materials such as cross-linked polyurethanes, cyanate esters, epoxies, or silicones also can be used to maintain the shape of the interconnected layers while coatings on the material maintain low contact resistance. For example, a silicone layer can be patterned and cured on the surface of a fuel cell subcomponent. Or a high T_{g} silicone filled with carbon nanotubes can be stamped or overmolded to create a conformal layer within the fuel cell structure.

In other embodiments thermoset polymeric precursors can be applied to connected layers and then further converted to a network structure by a thermal, UV, or microwave curing step. For example, a layer of low molecular weight silicone precursors can be coated to the surface of the polymer material and then vulcanized to create a thermoset interconnect layer. Using low viscosity thermoset precursors also enables alternative manufacturing methods to apply patterned polymeric structures for fuel cell stacks.

In a further aspect the present disclosure provides a metal and polymeric composite BPPs that combines high thermal conductivity (stamped/patterned metals) with expanded design capabilities on the surface of the bipolar plates through the use of polymeric composites. More particularly, in accordance with the present disclosure we combine thin, and thus lightweight, sheets of highly conductive metal such as aluminum, beryllium or magnesium and their alloys with shaped, lightweight composite materials to create metal and polymer composite BPPs.

BPPs in accordance with the present disclosure consist of two plates made of two different materials: a metal base plate (preferably forming the anode plate) and a polymer composite plate (preferably forming the cathode plate). The two plates are electrically connected to each other. Anode and cathode channels are formed on outer surfaces of anode and cathode plates respectively.

A feature and advantage of the present disclosure is that the metal base plate layer provides high thermal conductivity, while the polymer composite material layer enables the formation of deep and narrow channels with well-defined corners on a surface of the BPPs independent of the metal base plate. This is especially important for cathode and coolant channels.

The polymer composite layer is formed of a high T_{g} and chemically resistant polymeric composite material, which provides good electrical contact and anti-corrosion protection for metal parts of the plate under a wide range of operating temperatures. Preferred high T_{g} and chemically resistant polymeric material may be selected from the group consisting of polyvinylidene fluoride, a polysulfone polymer selected of the group consisting of polyphenylsulfone, polyethersulfone and mixtures thereof, a polyaniline, a polythiophene, a poly(pyrrole), a polybenzimidazole, a polyethersulfone, a fluorinated ethyl-polypropylene, a perfluoralkoxy, and mixtures thereof, and may include carbon nanotubes and/or carbon black, graphitized carbon particles, amorphous carbon particles and graphite sheets, and mixtures thereof.

In such embodiment the conductive carbon particles preferably comprise carbon black particles comprising up to 25 mass % of the polymeric composite material layer(s), and/or carbon nanotubes comprising up to 20 mass % of the polymeric composite material layer, and mixtures thereof.

In one embodiment the metal base plate is coated with multiple layers of metal or polymeric composite materials to improve the corrosion resistance and electrical contact conductivity of the bipolar plate material while maintaining its thermal and electronic properties. In such an embodiment, it is important that at least one layer in the composite structure has high thermal conductivity to ensure sufficient heat redistribution along the BPP and, thus, reducing temperature gradients typical for air-cooled fuel cells. In such an embodiment, a metal such as aluminum is used to provide the majority of the necessary thermal conductivity. In other embodiments, the metal also creates a highly thermally conductive base layer. While aluminum and its alloys are electrically conductive, the majority of the benefit of the use of aluminum is in its thermal conductivity. In yet other embodiments lightweight thermally conductive metals such as magnesium and beryllium, and their alloys are used to create the metal base layer. With the present disclosure, the problems associated with deep narrow channels in patterning the metal base layer are eliminated, since the patterning of deep narrow channels can largely and readily be produced in the polymeric composite layer.

In practice of the disclosure, a metal sheet, e.g., formed of aluminum, is stamped, or milled with relatively wide and shallow channels, and one or more shaped layers of composite polymeric material having relatively narrow and deep channels is formed on or bonded to the aluminum layer whereby to produce a rigid, lightweight, thermally and/or electrically conductive, and corrosion resistant BPP. By way of example, the channels formed in the metal layer may have a width of 1.0 to 2.5 mm, optimally 1.5 mm, and a height of 0.2 to 0.5 mm, optimally 0.5 mm. Channels formed in the polymer composite layer may have a width of 0.5 to 3 mm, optimally 1.0 to 2.0 mm, and a height of 0.3 to 2.0 mm, optimally 1.0 mm. The resulting composite BPP structures are arranged within a fuel cell stack.

In one embodiment, the composite polymeric material layer is preformed or patterned, and then bonded to the surface of the metal layer to create a BPP structure with deep and narrow channels, which improves reactant and/or heat flow throughout the stack.

In another embodiment the composite polymeric material is coated on the metal layer, and then patterned.

The polymeric composite materials can be performed or applied to and/or patterned on the metal layer surface by injection molding, overmolding, vacuum forming, slot-die coating, laser etching, chemical etching, spraying, extrusion, lamination, solvent casting, powder coating, sol-gel coating, formed additively such as by 3-D printing, or coating/slitting or the like. The polymeric composite material layer of the BPP may be modified and adapted to provide different electrical T_{g} thermal, e.g., coefficient of thermal expansion (CTE), conductivity, and chemical resistance properties. For example, in one embodiment a polyaniline material doped with carbon nanotubes can be applied to the metal layer to increase its electrical and thermal conductivity. In another embodiment the CTE of the polymeric composite layer can be modified to more closely match that of the metal layer.

In yet another embodiment, a functional layer may be embedded within the polymeric composite layer to improve the performance of the fuel cell. For example, a catalyst layer can be embedded in the polymeric composite layer.

In one embodiment the polymeric composite material contains a blend of a polymeric base material and electrically conductive particles such as carbon black, and carbon nanotubes. In other embodiments materials such as graphene sheets, metal wires, metal particles, double-walled carbon nanotubes, or ceramics, can be added to increase the electrical and/or thermal conductivity of the polymeric composite layer.

In yet another embodiment, electrically conductive polymers can be incorporated into the polymer composite layer, including polyanilines, polythiophenes, poly(3,4-ethylenedioxythiophenc), (PEDOT), poly(pyrroles), polyphenylsulfone (PPS), polyaniline (PANI), doped and undoped polybenzimidazole. In other embodiments, electrical and/or thermal conductive polymers and additives can be blended to further modify the polymer composite layer. For example, polysulfones can be blended with polythiophenes to improve the polymer composite layer's chemical resistance while maintaining high thermal and/or electrical conductivity.

A particular feature and advantage of BPPs made in accordance with the present disclosure are high flexural and elastic moduli and high T_{g} of the patterned layer on the BPP which is a critical property for maintaining structural features at elevated operating temperatures. Without structural integrity any benefits to improved transport of working gas or coolant media from channel patterning are lost.

In one embodiment thermoplastic materials with high T_{g} and chemical resistance can be used to add mechanical stiffness to the polymer composite layer such as: polyvinylidene fluoride (PVDF), polybenzimidazole (PBI), polyether ether ketone (PEEK), Thermoplastic polyimide (TPI), polyethersulfone (PESU), polyphenylsulfone (PPSU), Fluorinated ethylene-propylene (FEP), perfluoroalkoxy (PFA), polyetherimide (PEI), or polyamide (PA). In another embodiment, two or more polymer materials are applied in a multilayer structure, e.g. PA is applied first then coated with PEEK to maintain structural integrity at high operating temperatures.

In a further embodiment, thermoplastic materials can also be applied as polymeric composite blends. For example, PPSU can be blended with PTFE then applied to the BPP to improve the chemical resistance of the material.

Thermoset polymeric materials also can be applied as the polymer composite layer to provide structural integrity, e.g., thermally resistant epoxy coatings. The thermoset materials can be stamped on the surface of the metal layer in the desired structure and cured in place to preserve the desired geometric features. This process can be accomplished by laminating, casting, or overmolding. Thermoset materials provide additional dimensional stability at elevated temperatures as these materials soften at the T_{g}, but will not melt and flow. Thermoset materials can be blended with thermally and electrically conductive fillers to further modify the performance of the BPP. Thermoset polymeric precursors can also be applied directly to the metal layer in a molded pattern then converted by a UV, thermal, or microwave curing step. For example, a two-component epoxy layer can be mixed and applied to the metal layer using a stamping mold then solidified directly on the surface following a thermal curing schedule.

A particular feature and advantage of the BPP structure according to the present disclosure is the ability to pattern the polymer composite layer in three dimensions using both layer by layer coating (z-direction) and material patterning (xy-direction) within the polymeric composite structure.

Direct patterning of desired features on the surface of the BPP allows control of the size and aspect ratio of features. For example, a rigid structural material can be applied in a desired geometry by overmolding in a precise location. Additionally, this process allows for precise control of the size and aspect ratio of features enabling smaller geometries on the surface of the BPP.

The disclosure specifically targets lightweighting of fuel cells as the desired application. However, composite conductive structures like those discussed in this disclosure also can be applied to create lightweight, power dense battery structures, and other electronic devices.

According to another aspect of the present invention there is provided a BPP formed of two layers made of different materials: a metal base layer and a polymeric composite layer, wherein the metal base layer and the polymeric composite layer are electrically connected to one another, and wherein channels are formed on outer surfaces of the metal base layer and the polymeric composite layer.

Preferably the channels formed in the polymeric composite layer are narrower than the channels formed in the metal layer.

Preferably the channels formed in the polymeric composite layer are deeper than the channels formed in the metal layer.

Preferably the polymeric composite layer is formed of a high T_{g} and chemically resistant polymeric composite material.

Preferably the high T_{g} and chemically resistant polymeric material is selected from the group consisting of polyvinylidene fluoride, a polysulfone polymer selected of the group consisting of polyphenylsulfone, polyethersulfone and mixtures thereof, a polyaniline, a polythiophene, a poly(pyrrole), a polybenzimidazole, a polyethersulfone, a fluorinated ethyl-polypropylene, a perfluoralkoxy, and mixtures thereof.

Preferably the high T_{g} and chemically resistant polymeric material includes carbon nanotubes and/or carbon black, graphitized carbon particles, amorphous carbon particles and graphite sheets, and mixtures thereof.

Preferably the channels formed in the surface of the metal base layer have a width of 1.0 to 2.5 mm and a height of 0.2 to 0.5 mm.

Preferably the channels formed in the surface of the polymeric composite layer have a width of 0.5 to 3.0 mm and a height of 1.0 to 2.0 mm.

Preferably the metal base layer is formed of a metal selected from the group consisting of aluminum, beryllium, magnesium and alloys thereof.

According to a further aspect of the present invention there is provided a fuel cell comprising a BPP formed of two layers made of different materials, a channeled metal base layer and a channeled polymeric composite layer according to aspect A of the present invention.

Preferably the channeled metal base layer forms the fuel cell anode plate, and the channeled polymeric composite layer forms the fuel cell cathode plate.

According to yet another aspect of the present invention there is provided a fuel cell stack comprising a plurality of fuel cells as according to aspect B of the present invention.

According to a further aspect of the present invention there is provided a method for forming a BPP for a fuel cell, comprising providing a contoured metal base, and covering one surface of the contoured metal base with a contoured polymeric composite layer.

In one alternative the contoured metal plate and contoured polymeric composite layer are fixed to one another in a roll-to-roll process.

In another alternative the contoured polymeric composite layer is formed on the countered metal base layer.

In one alternative the contoured polymeric composite layer is formed of an additive process.

In another alternative the contoured polymeric composite layer is formed by molding.

In a further alternative the contoured polymeric composite layer is formed by a subtractive process.

In one alternative the contoured metal base layer and the contoured polymeric composite layer are separately formed and affixed to one another.

According to another aspect of the present invention there is provided a method for forming a BPP for a fuel cell, comprising providing a contoured metal base, and covering one surface of the contoured metal base with a contoured polymeric composite layer.

In one alternative the contoured metal plate and contoured polymeric composite layer are fixed to one another in a roll-to-roll process.

In another alternative the contoured polymeric composite layer is formed on the countered metal base layer.

In one alternative the contoured polymeric composite layer is formed of an additive process.

In another alternative the contoured polymeric composite layer is formed by molding.

In a further alternative the contoured polymeric composite layer is formed by a subtractive process.

In one alternative the contoured metal base layer and the contoured polymeric composite layer are separately formed and affixed to one another.

According to a further aspect of the present invention there is provided a fuel cell powered vehicle.

Preferably the vehicle comprises a fuel cell powered aircraft.

In still yet another embodiment of the disclosure there is provided a fuel cell BPP having an anode plate and a cathode plate, and a plurality of gaseous media coolant flow channels therebetween, wherein the gaseous media coolant flow channels each have an inlet and an outlet, wherein at least one of the gaseous media coolant flow channels varies in size between its inlet and outlet and includes an expansion area, and wherein at least one of the gaseous media coolant flow channels has an inlet that is smaller in size than its outlet.

In one embodiment one or more of the gaseous media coolant flow channels increase in size downstream of their respective inlets.

In another embodiment one or more of the gaseous media coolant flow channels include deflection barriers configured to force the gaseous media coolant from a straight path within said channel(s).

In a further embodiment two or more of the gaseous media coolant flow channels have staggered deflection barriers between their respective inlets and outlets.

In yet another embodiment two or more of the gaseous media coolant flow channels have deflection barriers of varying lengths and positions between their respective inlets and outlets.

In a still further embodiment one or more of the gaseous media coolant flow channels are configured in a pattern that provides a gradual increase of heat rejection efficiency between their respective inlets and outlets.

In yet another embodiment one or more of the gaseous media coolant flow channels have deflection barriers configured to cause the gaseous media coolant to change flow direction.

In still yet another embodiment one or more of the gaseous media coolant flow channels have deflection barriers configured to cause the media gaseous coolant to gaseous media coolant flow channel.

In another embodiment two or more of the gaseous media coolant flow channels increase in size downstream of their respective inlets.

In a further embodiment the gaseous media coolant flow channels are narrowest at their respective inlets as compared to their respective outlets.

In yet another embodiment the BPP has a rectangular shape in plan.

In a further embodiment the BPP has a trapezoidal shape in plan.

In another embodiment the BPP has a ring-sector shape in plan.

In still yet another embodiment the anode plate is formed of a metal, and the cathode plate is formed of a polymeric composite material.

In a further embodiment the anode plate has a plurality of anode reactant gas flow channels running parallel to one another, the cathode plate has a plurality of cathode reactant gas flow channels running parallel to one another and parallel to the anode reactant gas flow channels, and the gaseous media coolant flow channels run at an angle to the anode reactant gas flow channels and the cathode reactant gas flow channels.

In another embodiment the coolant media flow channels run perpendicular to the anode reactant gas flow and the cathode reactant gas channels.

The present disclosure also provides a fuel cell stack comprising a plurality of fuel cell bipolar plates.

The present disclosure also provides a fuel cell powered vehicle comprising a fuel cell stack as described above, in particular a fuel cell powered vehicle in the form of a fuel cell powered aircraft.

Preferably the anode plate is formed of a metal, and the cathode plate is formed of a polymeric composite material.

Preferably the anode plate has a plurality of anode reactant gas flow channels running parallel to one another, the cathode plate has a plurality of cathode reactant gas flow channels running parallel to one another and parallel to the anode reactant gas flow channels, and the gaseous media coolant flow channels run at an angle to the anode reactant gas flow channels and the cathode reactant gas flow channels.

Preferably the coolant media flow channels run perpendicular to the anode reactant gas flow channels and the cathode reactant gas channels.

Preferably one or more of the gaseous media coolant flow channels have deflection barriers configured to cause the gaseous media coolant to change flow direction.

Preferably the deflection barriers are configured to cause the gaseous media coolant to divide into parts, wherein a part moves forward, and a part moves horizontally around a deflection barrier in a direction of an adjacent gaseous media coolant flow channel.

According to another aspect of the present invention there is provided a fuel cell stack comprising a plurality of fuel cell bipolar plates according to aspect O of the present invention.

According to yet another aspect of the present invention there is provided a fuel cell powered vehicle comprising a fuel cell stack as above described.

Preferably the vehicle comprises a fuel cell powered aircraft.

Further areas of applicability will become apparent from the description provided herein. The description and specific examples in this summary are intended for the purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

FIG. 1 is a perspective view, FIG. 1a is a cross-sectional view, and FIG. 2 is an exploded view of a fuel cell in accordance with the prior art;

FIG. 3 is a cross-sectional view of a fuel cell in accordance with the prior art;

FIG. 4 is a cross-sectional view of a corrosion-resistant electrically conductive element in accordance with one embodiment of the instant disclosure;

FIG. 5 is a flow diagram illustrating a process for producing the corrosion-resistant electrically conductive element shown in FIG. 4;

FIG. 6 is cross sectional view similar to FIG. 4, of another embodiment of corrosion-resistant electrically conductive element in accordance with the present disclosure;

FIG. 7 is a flow diagram similar to FIG. 5, illustrating a process for producing the corrosion-resistant electrically conductive element shown in FIG. 6;

FIG. 8 is a cross-sectional view of a HT-PEM hydrogen fuel cell in accordance with the instant disclosure;

FIG. 9 is a schematic view of a HT-PEM hydrogen fuel cell powered aircraft in accordance with the instant disclosure;

FIG. 10 is a cross sectional view of a HT-PEM fuel cell in accordance with the present disclosure;

FIG. 11 is a flow diagram illustrating a process for forming a HT-PEM fuel cell in accordance with the present disclosure;

FIG. 12 is a schematic depiction of a hydrogen fuel cell powered aircraft in accordance with the present disclosure;

FIG. 13 is a cross-sectional view of a BPP made in accordance with the present disclosure;

FIGS. 14-16 are flow diagrams illustrating processes for forming a BPP in accordance with the present disclosure;

FIG. 17 is a cross-sectional view of a stack of fuel cells incorporating BPPs in accordance with the present disclosure;

FIG. 18 is a schematic depiction of a hydrogen fuel cell powered aircraft in accordance with the present disclosure;

FIG. 19 is a perspective view of a fuel cell and FIG. 19A is a top plan view of the coolant channels of an anode plate of a fuel cell in accordance with the present disclosure;

FIGS. 20-21 are top plan views of an anode or cathode plate, illustrating the gaseous media coolant flow channels in accordance with the present disclosure; and

FIG. 22 is a schematic depiction of a hydrogen powered aircraft in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Also, as used herein in describing the flow channels as running adjacent to one another, the term “parallel” shall mean the flow channels as having essentially the same distance continuously between them, or running substantially parallel where the distance between adjacent flow channels varies depending on the shape of the plate. Thus, in the case of a bipolar plate that is substantially rectangular in shape, the flow channels may run essentially parallel to one another, while in the shape of a BPP formed as a trapezoid or ring-sector shape, the flow channels may deviate from one another by 5, 10, 15, 20, 25 or even 30° depending on the shape of the BPP.

Also, as used herein, in describing the gaseous media coolant flow channels as running transverse or perpendicular to the gaseous reactant gas flow channels shall mean that the respective channels are “perpendicular”, i.e., running at right angles (90°) to one another, or running transverse to one another at 90°±5, 10, 15, 20, 25 or even 30° from perpendicular.

When an element or layer is referred to as being “corrosion-resistant” or “chemically resistant”, it is with reference to the electrolyte used in the fuel cell. In the case of a HT-PEM fuel cell, the electrolyte may be phosphoric acid.

When a polymer is referred to as having a high T_{g} it is in reference to the working temperature of a HT-PEM fuel cell, plus a margin of safety. For the purposes of the instant disclosure, a polymer having a T_{g} of 170-230° C. shall be considered as having a high Te.

When the polymeric composite material and the coating on the BPP surface are referred to as having matched thermal expansion coefficients, their respective thermal expansion coefficient preferably should be within 5% of one another, more preferably within 3% of one another, even more preferably within 1% of one another.

Also, when the polymeric composite material and the coating on the BPP surface are referred to as having similar electrical conductivity properties, their respective electrical conductivity properties, preferably should be within 5% of one another, more preferably within 3% of one another, even more preferably within 1% of one another.

Also, as used herein the terms “component” and “subcomponent” are employed interchangeably to describe the several elements forming our HT-PEM cells.

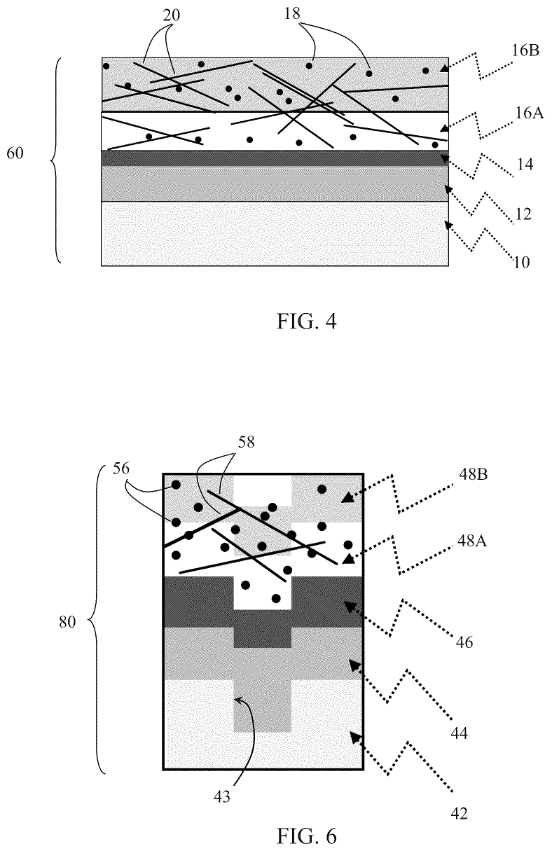

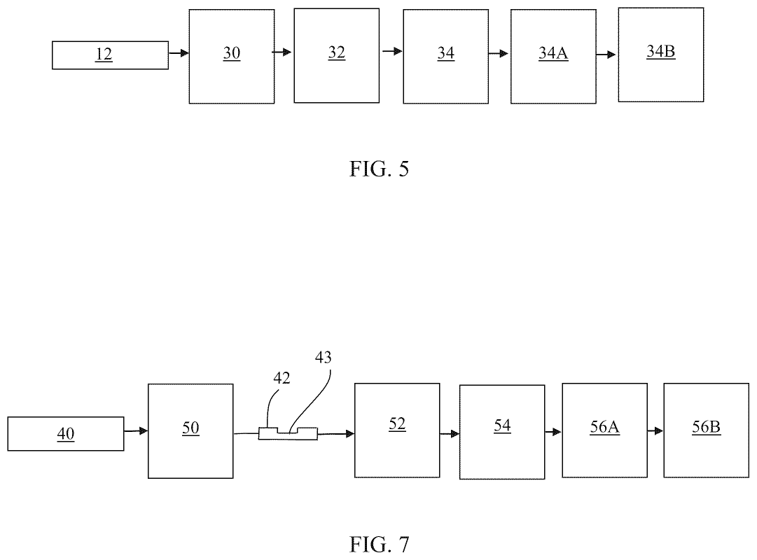

Referring to FIGS. 4 and 5, an electrically conductive metal plate 10 is formed (e.g., stamped, rolled, or etched) to create a bare metal structure suitable for forming a bipolar plate in a HT-PEM hydrogen fuel cell. Metal plate 10 is formed of lightweight, conductive metal (e.g., aluminum, magnesium, or titanium) plate and is coated with a corrosion-resistant, nickel-containing metal layer 12 such as nickel/rhenium/phosphorus (NiReP) by electroless deposition or electroplating in a first plating step 30 (FIG. 5). A thin layer 14 of noble metal or a precious metal such as gold is then deposited over the NiReP layer 12 by electroless or electroplating in a second plating step 32. One or more layers of a corrosion-resistant high T_{g} polymer composite material 16A, 16B containing electrically conductive carbon particles, preferably carbon black 18 and/or carbon nanotubes 20 is then applied over the precious metal layer 14 in coating steps 34, 34A, 34B to create a composite aluminum bipolar plate 60.

Carbon black and carbon nanotubes are available commercially in a variety of sizes from a variety of sources. Commercially available carbon black may have a particle size of range of from about 20 nm to 350 nm or more. Preferred carbon black particle size range when used in accordance with the present disclosure is 40 to 60 nm. Commercially available carbon nanotubes typically have a diameter of about 1-3 nm, and a length that is much higher than its diameter, typically several μm. Preferred carbon nanotubes when used in accordance with the present disclosure have a length equal to or more than 5 microns and particle size distributions of D10 (1.2-1.45 nm), D50 (1.6-1.8 nm), and D90 (1.9-2.2 nm) with an aspect ratio similar to an elongated tube.

Preferably multiple layers 16A, 16B . . . of the corrosion-resistant high Te polymer composite material are applied to the corrosion-resistant metal layer 14. By way of example, one layer 16A may be polyvinylidene fluoride (PVDF) polymer material containing carbon black and graphene nanoparticles. Another layer 16B . . . may be a PSU polymer material (e.g., PPSU or PESU) containing carbon black and carbon nanotubes. Each polymer composite material layer 16A, 16B . . . may be applied in a layer-on-layer technique using spray coating. Spray coating gives more consistent coverage of polymeric layers. A number of high Te polymeric composite material layers may be applied. The high T_{g} polymeric layers 16A, 16B . . . also may be applied using dipping, brush painting, blade coating, thermal spraying, plasma deposition, flow coating, spin coating, sol-gel, dip coating, powder coating, or surface grafting techniques.

Carbon black and carbon nanotubes may be incorporated into the PVDF and PSU layers at approximately the same or different ratio. However, the ratio of nanotubes to carbon black affects conductivity. Accordingly, carbon black is loaded at a range of up to 25% by mass and nanotubes is loaded at a range of up to 20% by mass. Care should be taken to avoid adding more than about 25% by mass carbon black, since too much carbon black can serve as a bridge for phosphoric acid leading to degradation of the coating layer.

A representative electrically conductive corrosion-resistant element in accordance with the present disclosure comprises a 200 μm thick aluminum plate layer 12, having a 5 μm thick electrodeposited NiReP coating layer 14, on which is electroless coated a 5 nm thick layer of gold. A first 3 μm thick polymer composite layer, formed of PVDF containing a mixture of carbon black particles and carbon nanotubes, is spray coated over the gold layer. A second 5 μm thick polymer composite layer formed of PPSU or PESU containing a mixture of carbon nanotubes and carbon black, is spray coated over the PVDF-layer.

Polymers from the PSU family improve corrosion resistance and lower contact resistance at elevated operating temperatures. Preferred are PPSU and PESU. In other embodiments, only one PSU polymer material may be used. In another embodiment two or more layers may be combined, e.g., to provide a blended PPSU-PVDF composite.

An important feature of the instant disclosure is that the polymeric composite material and the coating on the BPP surface should have matched thermal expansion coefficients, in order to maintain the bond between layers over extended thermal cycling. Also, both the polymeric composite material and coating on the BPP surface preferably should have similar electrical conductivity properties, enabling minimum additional electric contact resistance.

Referring to FIGS. 6 and 7, in accordance with another embodiment a conductive, lightweight metal sheet 40 formed of aluminum, magnesium or titanium is stamped or etched in a forming step 50 to create a contoured bipolar metal structure 42 having one or more channels 43.

The contoured metal plate structure 42 is then coated with a NiReP layer 44 in a first plating step 52. As before the nickel containing layer may be applied by electroplating.

A thin layer (5 nm) of gold 46 is applied to the surface of the nickel containing alloy layer using electroless plating or electroplating in a second plating step 54. The electroplated layer coating the alloyed corrosion-resistant structure is selected for improved conductivity, corrosion resistance as well as inert properties. One or preferably multiple layers 48A, 48B of polymeric composite containing carbon black particles 56 and graphite nanotubes 58 are applied in a coating step or steps 56A, 56B . . . as before, to create a contoured composite aluminum bipolar plate 80.

As before, the nickel layer and the corrosion-resistant metal layer are applied using electroless plating or electrolytic plating. In other embodiments metal coatings may be applied using chemical vapor deposition (CVD), plasma enhanced CVD, low pressure CVD, sputtering, chemical bath deposition, laser beam evaporation, sol-gel deposition, molecular beam epitaxy, vacuum thermal evaporation, or spray pyrolysis.

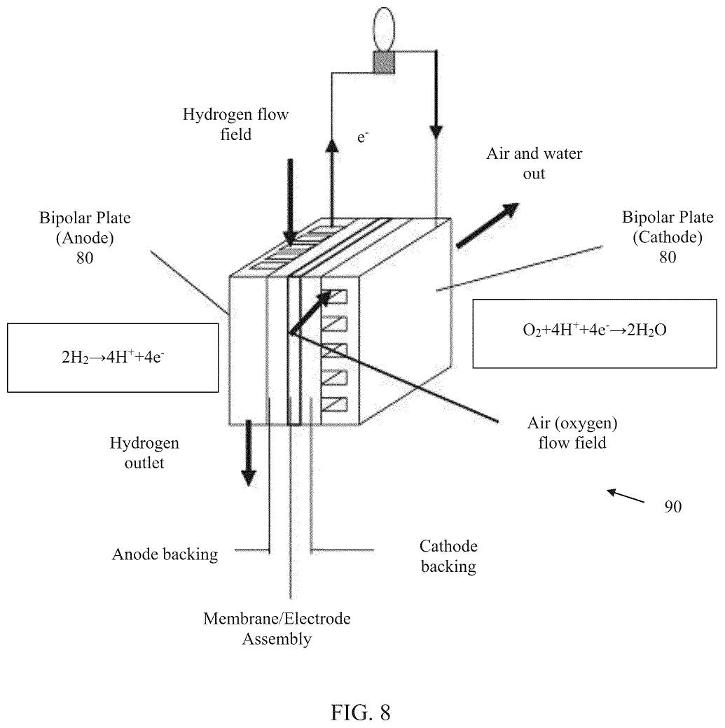

Referring to FIG. 8, composite aluminum bipolar plates 80 of FIG. 6 are incorporated as a bipolar plate in a high temperature PEM fuel cell 90 equipped to run on hydrogen gas.

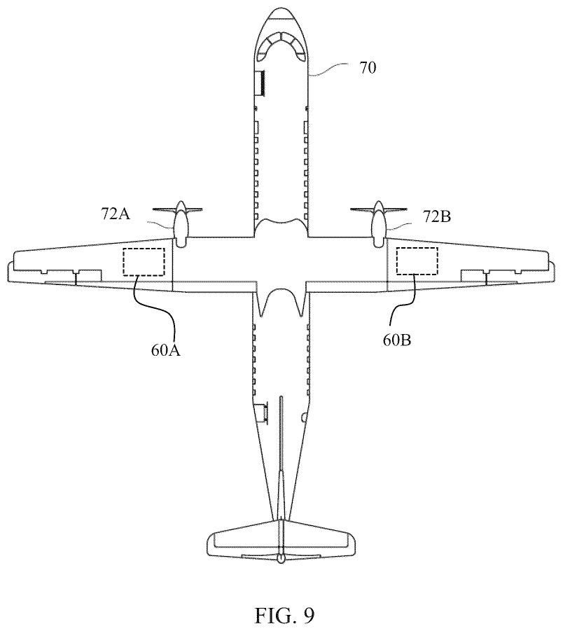

FIG. 9 illustrates an aircraft 70 including two electric motors 72A, 72B which are weighted by two parallel HT-PEM hydrogen fuel cells 60A, 60B in accordance with FIG. 8.

Various changes may be made in the above disclosure. For example, in other embodiments multiple layers of high T_{g} polymer composite material layers may be arranged in a different order or combined and stacked to access unique properties. For example, one layer of PPSU and one layer of PESU may be coated on a layer of PVDF to create a three-layered polymer composite structure. Alternatively, two or more layers of PPSU composite may be applied to the PVDF layer.

Also, the high T_{g} polymer composite material layers may be applied for different functional purposes. For example, the PVDF layer may be incorporated for its barrier and adhesion promotion properties. In yet another embodiment, alternative methods for improved adhesion may be used to improve contact of the PSU layer with the nickel-containing corrosion-resistant layer such as plasma treatment, application of adhesion promoter compounds, or use of an alternative polymer material. In yet another embodiment the PSU layer is incorporated for its high glass transition temperature and improved chemical resistance to corrosion. The molecular weight of PSU influences the T_{g} of the PSU layer. Thus, the PSU materials may be selected to meet the appropriate operating conditions of the HT-PEM fuel cell.

In yet other embodiments, the polymer materials may be blended to take advantage of properties exhibited by each material. For example, a polymer with good metal adhesion properties such as PVDF or epoxy-based coatings may be blended with highly chemically resistant materials such as polyether ether ketone (PEEK) or PPSU.

In other embodiments, conductive structures such as aluminum or carbon structures, graphene sheets, multiwalled carbon nanotubes, graphitized carbon particles, amorphous carbon particles, metal oxides, metallic particles, coated metal structures, wires or mats also may be melt embedded or blended in the high T_{g} polymer composite layer (e.g. polysulfone) and then adhered to the PVDF layer to improve electrical connectivity through the composite high-temperature polymer coating layers.

Additionally, the high T_{g} polymer composite layer may be applied to a composite plate structure composed of the PVDF or PSU matrix filled with conductive metal or carbon particles, creating an entirely polymer-based and corrosion-resistant bipolar plate structure.

In yet other embodiments, distinct PVDF and PSU layers may be applied at different thicknesses, composite filler ratios, or omitted to achieve different properties. Also, thickness, chemical composition, T_{g}, conductivity, etc., may be adjusted by changing the molecular weight of components in the composite blend. The molecular weight of PSU in the blend may be adjusted to achieve a Te range of 170-230° C. while maintaining low contact resistance.

The polymeric layer improves the corrosion resistance and adds barrier properties to the bipolar plate. In other embodiments, conductive polymers also may be blended into the composite material to affect the electronic properties of the bipolar plate. Other high T_{g} conductive polymers that can serve this purpose include polyanilines, (PANI) polythiophenes, poly(3,4-cthylenedioxythiophene (PEDOT), poly(pyrroles), and polyphenylsulfone (PPSU). In other embodiments high T_{g} and chemically resistant polymers such as polybenzimidazole (PBI), polyether ether ketone (PEEK), Thermoplastic polyimide (TPI), polyethersulfone (PESU), Fluorinated ethylene-propylene (FEP), perfluoroalkoxy (PFA), also may be used to create composite structural layers.

While presented here for use in HT-PEM fuel cell systems, this metal and polymer composite material has other potential applications, including battery manufacturing, electrolyzers, and electronics circuit board and device manufacturing. Also, where weight is not as much a consideration such as in the case of terrestrial and water vehicles, or in the case of stationary HT-PEM fuel cell powered installations, the electrically conductive substrate may be formed of other, higher density metals such as copper, nickel, or stainless steel.

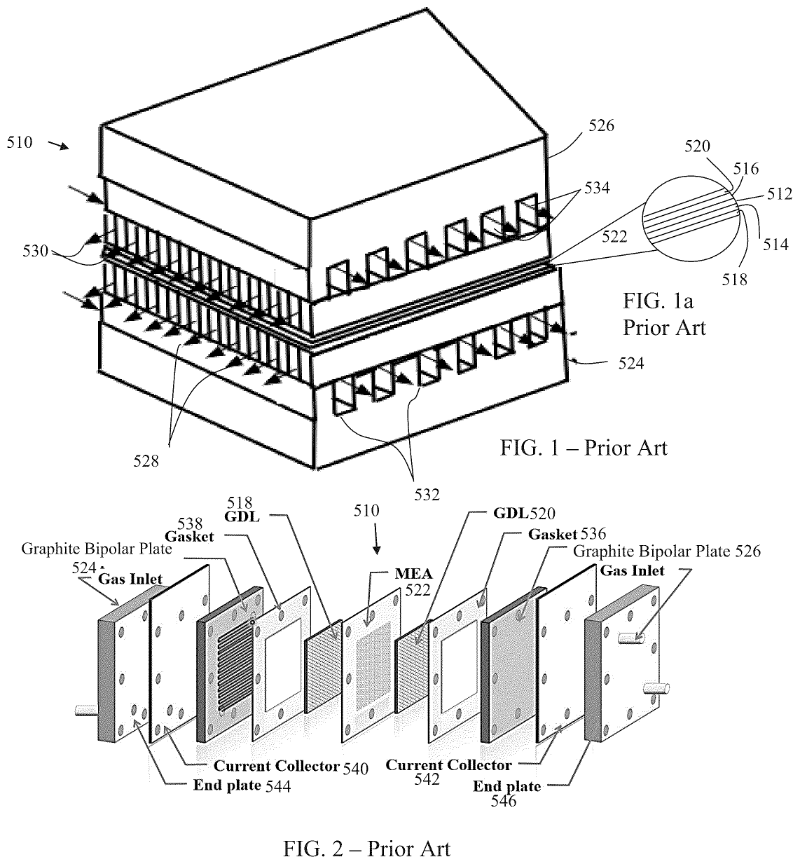

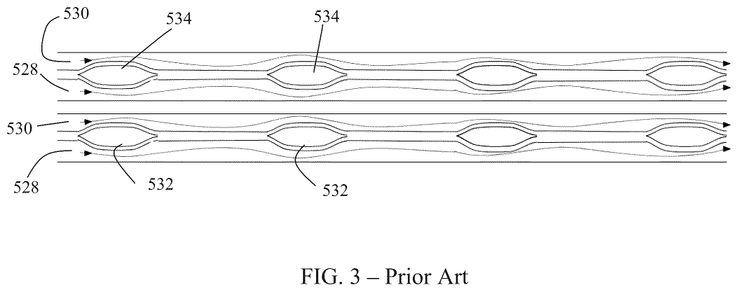

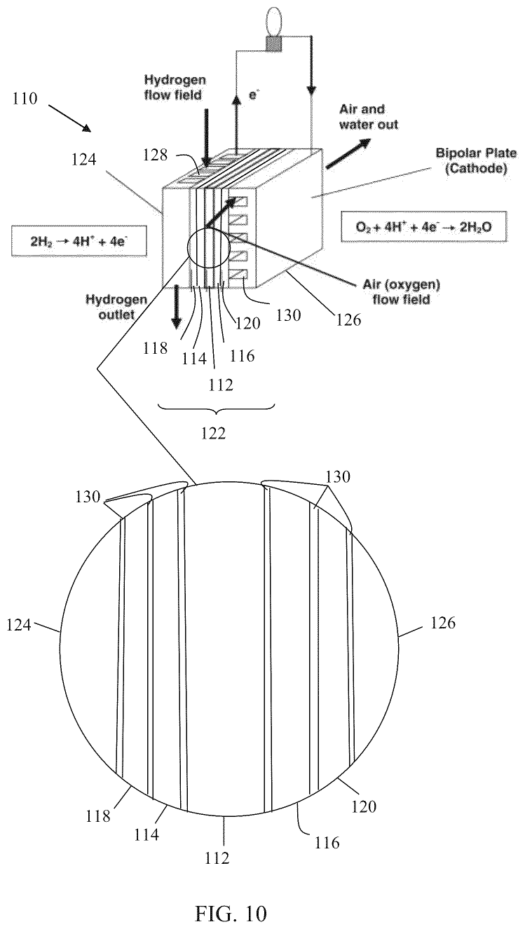

Referring to FIG. 10, a HT-PEM fuel cell 110 in accordance with the present disclosure is similar to the prior art HT-PEM described above in FIG. 1, and includes a PEM 112, typically formed in a specially treated polymer material that conducts only positive charged ions, and blocks electrodes. Catalyst layers are provided on both sides of the PEM 112—an anode catalyst layer 114 on one side, and a cathode catalyst layer 116 on the other. Gas Diffusion Layers (GDLs) 118, 120 sit to the outside of the catalyst layers 114, 116 and facilitate transport of reactants into the catalyst layers, as well as removal of the product water. The PEM 112, catalyst layers 114, 116 and the GDLs 118, 120 together make up the so-called MEA 122. As in the case of the prior art HT-PEM of FIG. 1, multiple MEAs 122 usually are connected in series by stacking them on top of one other to provide a usable output voltage. Accordingly, each cell in the stack is sandwiched between two BPPs 124, 126 to separate it from neighboring cells. Also, as before, the surfaces of the plates typically contain channels 128, 130 machined or stamped into the plates 124, 126 to allow gases to flow over the MEA 122. And, as before, additional channels (not shown) may be provided inside each plate to circulate a liquid coolant.

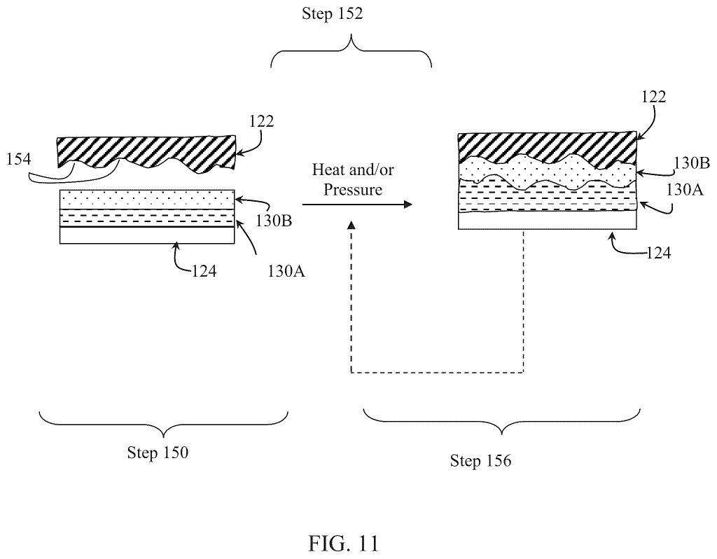

As distinguished from the prior art HT-PEM as described above, in accordance with the present disclosure one or more of the contacting surfaces of the MEA 122, i.e., surfaces of the PEM 112, the anode and cathode catalyst layers 114, 116, the GDLs 118, 120 and/or the BPPs are coated, at least in part with an electrically conductive composite material that softens at or below the operating temperature of the HT-PEM. Electrically conductive composite material may comprise one or a plurality of layers 130A, 130B (see FIG. 11). The layers each may have a different T_{g} and Tₘ.

Referring to FIG. 11, an HT-PEM in accordance with the present disclosure is formed as follows: a surface of one or more of the subcomponents of a fuel cell, such as a BPP 124 is coated at least in part with a layer of an electrically conductive polymer composite that softens at or below the operating temperature of the fuel cell in a coating step 150. In the illustrated case the electrically conductive polymer composite comprises two layers that are sequentially applied, a first layer 130A comprising a composite polymer material formed of PVDF containing 3-70% by volume conductive media, comprising a polymeric material formed of PESU containing 3-70% by volume conductive media. Conductive media may comprise one or more of 0 to 55% by volume carbon black and 0 to 30% carbon nanotubes. In other embodiments non-carbon conductive media may be used, e.g., conductive polymers (e.g., polyaniline, etc.), metals, and conductive metal oxides particles (e.g., RexOy). The coated BPP 124 subcomponent is then assembled with an MEA 122 subcomponent by pressing the two subcomponents together at a pressure of 0.1 to 100 kg/cm2 in a pressure step 152. Step 152 may last for as little as one second or as long as practical, though structure is usually formed within the first several seconds. In some embodiments, step 152 may be a heating and pressure step above the polymer interconnect T_{g}, e.g., at a temperature of 100 to 400° C. In some embodiments, only one composite polymer layer is used (i.e., 122, 124, 130A, 130B) and in other embodiments more than two composite polymer layers are used (i.e., 122, 124, 130A, 130B, . . . 130n). The polymer composite material layers 130A, 130B deform to match microstructures 154 on the mating surface(s) of the subcomponent(s), which improves interfacial contact and reduces contact resistance between layers. The assembly is allowed to cool, and the assembly may then be subjected to one or more additional heat and pressure cycles (step 156). Other subcomponents may similarly be assembled and joined together.

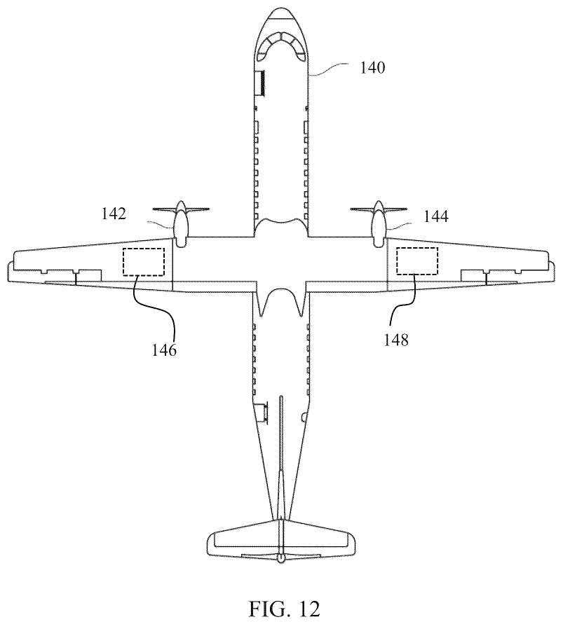

FIG. 12 illustrates an aircraft 140 including two electric motors 142, 144 which are powered by two parallel HT-PEM hydrogen fuel cells 146, 148 in accordance with FIG. 10.

While the foregoing disclosure focuses on using polymeric materials to maintain a conformal interface coating which lowers fuel cell contact resistance, other functional benefits can be incorporated into polymeric interconnect layers. For example, chemically resistant materials can be embedded in the stack to increase robustness against other media such as alkaline or acidic materials.

Also, while the foregoing disclosure is focused primarily on HT-PEM fuel cell applications, the composition of matter and manufacturing process disclosed can be adapted for use in electronic devices, battery manufacturing, or other areas where a high degree of interfacial electrical contact is desired, such as, for example press-fit or gas-tight electric connectors, sockets, pins and the like, particularly those designed for high temperature environments.

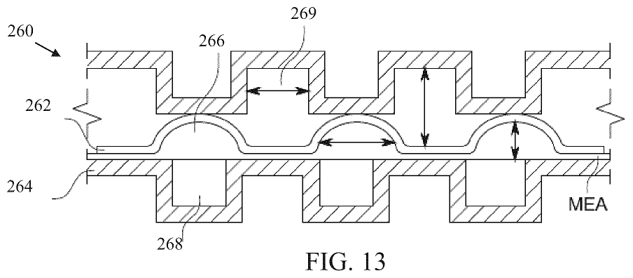

Referring to FIG. 13, a BPP 260 in accordance with the present disclosure comprises a shaped aluminum layer 262 and a polymer composite layer 264. Metal layer 262 is formed of aluminum having a thickness of 120-200 microns and is patterned to include a plurality of hydrogen gas flow channels 266. Channels 266 typically are 0.5 mm tall and 1.5 mm wide, respectively. Composite layer 264 is formed on aluminum layer 262 and includes a plurality of air flow channels 268 extending in opposite direction to channel 266. Composite layer 264 is formed of polysulfone or polyethersulfone and is approximately 500 microns thick. Channels 268 typically are about 2 mm wide and 1 mm high. Also shown in FIG. 13 are coolant channels 269. Channels 269 typically are 1 to 3 mm wide, optimally 2.0 mm wide and 0.5 to 2.0 mm tall, optimally 1.0 mm tall.

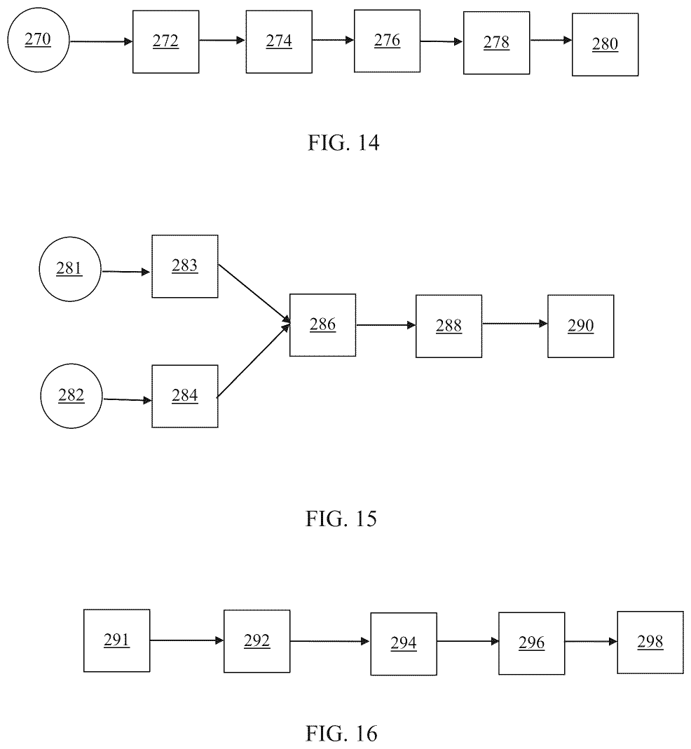

Referring to FIG. 14, in one embodiment a metal/polymeric composite BPP 260 is formed as follows: starting with roll aluminum 270, the aluminum strip is patterned in accordance with the present disclosure in a rolling station 272 to form a contoured channeled shape as shown in FIG. 13. The resulting contoured channeled aluminum strip is then coated in step 274 with a polymeric composite material, and the polymeric composite material layer is then subjected to laser etching in a laser etching step 276 to form deep, narrow channels as shown in FIG. 13. The resulting structure is then cut to size in a cutting station 278 and assembled with an MEA to form a fuel cell in assembly station 280.

Referring to FIG. 15, in an alternative embodiment, a metal/polymeric composite BPP in accordance with the present disclosure is formed by a roll-to-roll process, as follows: rolls of aluminum 281 and polymeric composite material 282 are patterned in rolling stations 283, 284, respectively to form contoured channeled shapes as shown in FIG. 13. The resulting patterned aluminum strip and patterned polymeric composite strip are then adhered together in an assembly station 286, and the resulting contoured aluminum/contoured polymeric composite assembly are then cut to size in a cutting station 288 and assembled with an MEA to form a fuel cell in assembly station 290.

Referring to FIG. 16, in another alternative embodiment, a metal polymeric composite BPP in accordance with the present disclosure is formed as follows: aluminum plates 291 are patterned in a stamping station 292 to form contoured channeled shapes as shown in FIG. 13. The contoured shaped aluminum plates are then coated on one side with a polymeric composite material at a coating station 294, and the polymeric composite material is then molded in a press in molding station 296 to form deep narrow channels as shown in FIG. 13. The resulting contoured aluminum/contoured polymeric composite assembly is then assembled with an MEA to form a fuel cell in assembly station 298.

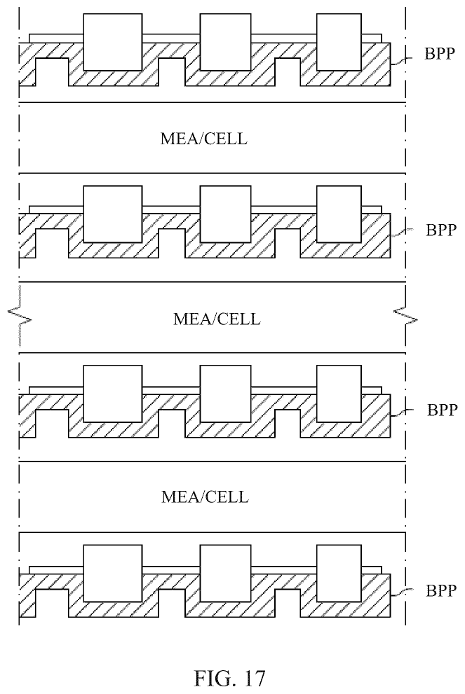

Referring to FIG. 17, a plurality of fuel cells are stacked together with BPPs made in accordance with the present disclosure to form a fuel cell stack.

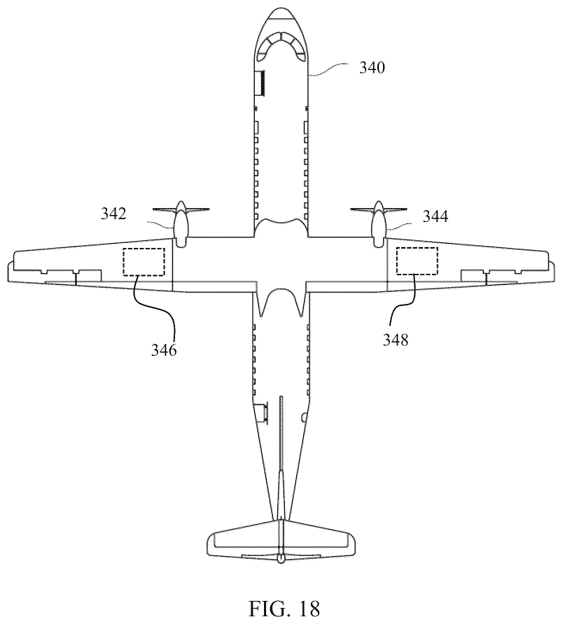

FIG. 18 illustrates an aircraft 340 including two electric motors 342, 344 which are powered by two parallel HT-PEM hydrogen fuel cells 346, 348 incorporating BPPs made in accordance with FIG. 17.

Also, while the foregoing disclosure is focused primarily on HT-PEM fuel cell applications, the devices and manufacturing process disclosed can be adapted for use in electronic devices, and battery manufacturing which are given as exemplary sockets, pins and the like, particularly those designed for high temperature environments.

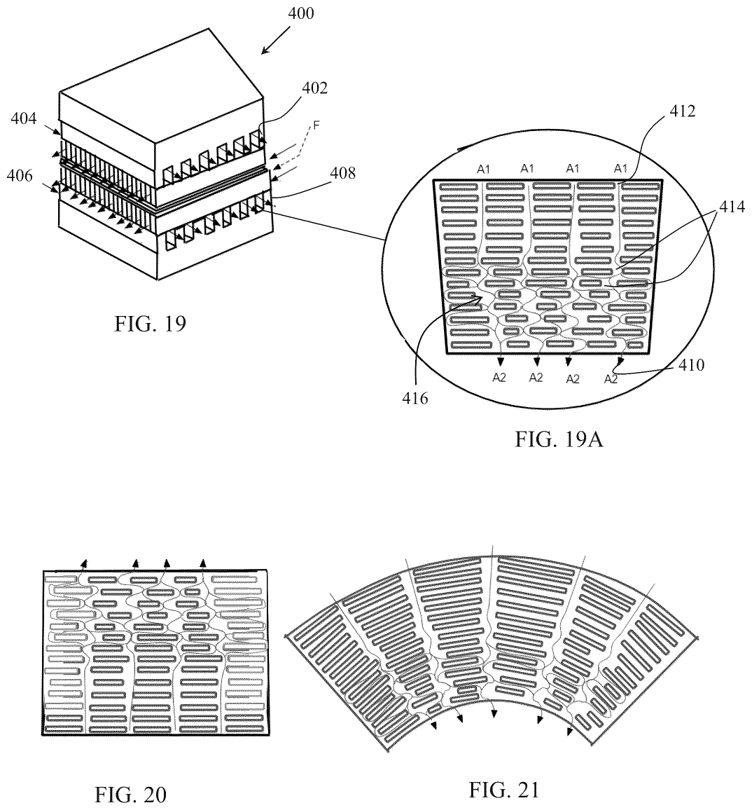

Referring to FIGS. 19 and 19a, there is illustrated a BPP 400 formed as a trapezoid in accordance with one embodiment of the present disclosure. BPP 400 is similar in overall construction and function as BPP 510 illustrated in FIG. 1, and is patterned with deep and narrow channels 402, 404, 406 and 408 on both sides, where the channels 404, 406 function to deliver reactants and the channels 402, 408 function to deliver cooling media (e.g., air). The individual reactant channels 404, 406 respectively run substantially parallel to one another, as do the coolant channels 402, 408. As a whole, the reactant channel and the coolant channels run substantially perpendicular to each other. The reactant and coolant channels forming the BPP may be comprised of metal, or preferably are formed of a novel metal-composite material as disclosed in our aforesaid UK Application No. GB2303807.8 (Attorney Docket No. CI-ZERO 23.05 UK), the contents of which are incorporated herein by reference, in a novel layout, in which the coolant channels 402, 408 have varying shapes and including an expansion area between the inlet 412 and outlet 410, and may include staggered deflection barriers with increasing spaces between channels 416.

A coolant deflection path is designed to be increasingly staggered as it proceeds from the inlet-side 412 of the BPP to the outlet-side 410. The inlet side 412 of the BPP starts with straight coolant channels 402 spaced closely to each other. The deflection barriers 414 force the coolant media to deviate from the initially linear path and allows for “bidirectional” motion, where not only vertical but also horizontal flow motion occurs. While part of the coolant continues its vertical path, the rest will take the longer path completely around the deflector.

Including narrow inlet 412 channel dimensions allows inlet channels to minimize heat rejection by the cold air on the initial part of its way through the BPP. In one embodiment of a trapezoidal or ring-sector BPP, a ratio of ⅓ to 1/10 between the initial channel width at the inlet to the BPP sector was found to prevent fuel cell overcooling from the edge where cold air enters.

In other embodiments, the coolant channel pattern can be adapted to have more narrow, shallow, and longer channels for transitioning from air cooling to evaporative cooling or for varying power output range, depending on the type of aviation application.

The BPP can be stamped, etched, or rolled into a trapezoidal or ring-sector shape to encompass a described coolant channel pattern.

The novel BPP multipath coolant channel pattern has linear rectangular channels with deflectors of varying lengths and positions in order to optimize efficiency of heat rejection. To achieve an evenly-distributed temperature across the cell, the pattern enables a gradual increase of heat rejection efficiency as cold air is heated so that maximum efficiency is provided at the exhaust end, where there is a very small temperature gradient between the fuel cell and the air, while at the intake end, the heat exchanging should be smaller to counter the already high gas velocity and avoid the air being saturated at its maximum temperature at the beginning of the cell.

Providing this novel flow channel shape with an expansion area and deflection barriers allows a 3-4 times reduction in coolant flow rate and more efficient cooling, thus enabling air vs liquid cooling. By way of example, in one embodiment as compared to employing a liquid which is heavy, only 0.8 kg/s air flow was required to reject 100 KW of heat rather than 2.9 kg/s. Thus, only 3% rather than 20% of the generated power is consumed for cooling.

Providing our BPPs with coolant channel patterns according to the present disclosure increases contact area of working gases, enabling greater thermal flux for more evenly distributed temperature. Thus, we are able to achieve as little as a 10° variation for 80% of the active area. As a result, the coolant channel pattern enables higher altitude aircraft where, at a lower air density, the thermal capacity of air is even lower which would otherwise unacceptably limit air-cooling efficiency. The coolant channel pattern also lends itself to radial fuel cell stack designs such as trapezoid or ring-sector plan shapes, which fit more securely in a coaxial system, airplane fuselage or nacelle inner space. The coolant channel patterns in accordance with the present disclosure also allow lightweighting for a lighter/smaller system. By way of example, the overall size of a heat exchanger cooling portion of BPPs made in accordance with the present disclosure may be reduced by up to 4 times resulting in a lighter/smaller system.

BPPs made with coolant channel patterns in accordance with the present disclosure also provide greater design flexibility, mechanical stability, and fuel cell stack rigidity, especially in a ring-sector shaped embodiment compared to traditional rectangular shape stacks that arc more difficult to align for taller stacks of higher output. This is especially important under vibration as may be encountered by an aircraft during take-off and climb.

The present disclosure provides several advantages: BPPs have not previously had a multi-path pattern combining linear rectangular channels to run perpendicular to uniform circular channels. With the present disclosure, thinner, narrower channels with intentionally-varied size throughout the cell readily can be formed by the novel manufacturing methods and composite material described in our aforesaid UK Application No. GB2303807.8 (Attorney Docket CI-ZERO 23.05 UK), the contents of which are incorporated herein by reference. This also provides us with flexibility of design depending on desired power output range and aircraft type.

FIG. 20 shows a BPP having a generally rectangular plan shape, and FIG. 21 shows a BPP having a ring-shaped plan shape in accordance with the present disclosure.

A plurality of fuel cell bipolar plates made in accordance with the present disclosure may be stacked together to form a fuel cell stack.

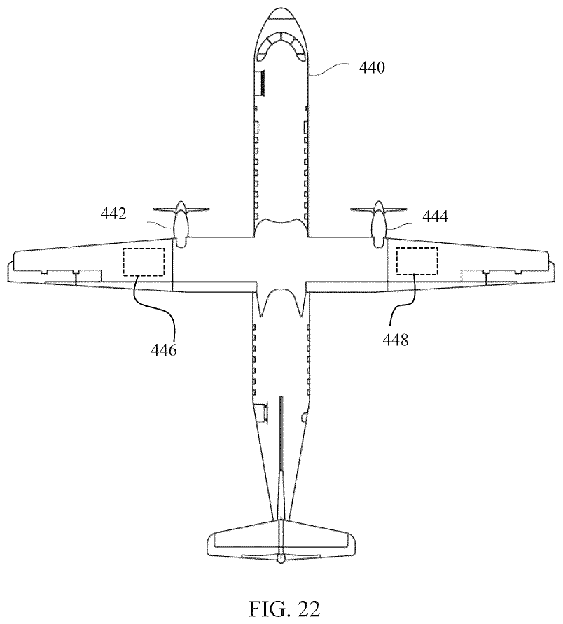

FIG. 22 illustrates an aircraft 440 including two electric motors 442, 444 which are powered by two parallel HT-PEM hydrogen fuel cells 446, 448 incorporating BPPs made in accordance with FIG. 19.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A bipolar plate (BPP) formed of two layers made of different materials which are connected together: a metal base layer and a polymeric composite layer formed of a high Te chemically resistant polymeric composite material selected from the group consisting of polyvinylidene fluoride, a polysulfone polymer selected of the group consisting of polyphenylsulfone, polyethersulfone and mixtures thereof, a polyaniline, a polythiophene, a poly(pyrrole), a polybenzimidazole, a polyethersulfone, a fluorinated ethyl-polypropylene, a perfluoralkoxy, and mixtures thereof, wherein the metal base layer and the polymeric composite layer are electrically connected to one another, and wherein channels are formed in an outer surface of the metal base layer and in an outer surface of the polymeric composite layer wherein the channels formed in the outer surface of the metal base layer have a width of 1.0 to 2.5 mm and a height of 0.2 to 0.5 mm, and wherein the channels formed in the outer surface of the polymeric composite sheet have a width of 0.5 to 3.0 mm and a height of 1.0 to 2.0 mm.

2. The BPP according to claim 1, wherein the channels formed in the polymeric composite layer are narrower than the channels formed in the metal layer.

3. The BPP according to claim 1, wherein the channels formed in the polymeric composite layer are deeper than the channels formed in the metal layer.

4. The BPP of claim 1, wherein the chemically resistant polymeric material includes carbon nanotubes and/or carbon black, graphitized carbon particles, amorphous carbon particles and graphite sheets, and mixtures thereof.

5. The BPP of claim 1, wherein the metal base layer is formed of a metal selected from the group consisting of aluminum, beryllium, magnesium and alloys thereof.

6. A fuel cell comprising a bipolar plate (BPP) formed of two layers made of different materials, a channeled metal base layer and a channeled polymeric composite layer as claimed in claim 1.

7. The fuel cell according to claim 6, wherein the channeled metal base layer forms the fuel cell anode plate, and the channeled polymeric composite layer forms the fuel cell cathode plate.

8. The fuel cell stack comprising a plurality of fuel cells as claimed in claim 6.

9. A method for forming a bipolar plate (BPP) for a fuel cell as claimed in claim 1, comprising providing a contoured metal base layer, and covering one surface of the contoured metal layer sheet with a polymeric composite layer formed of a polymeric composite material selected from the group consisting of polyvinylidene fluoride, a polysulfone polymer selected of the group consisting of polyphenylsulfone, polyethersulfone and mixtures thereof, a polyaniline, a polythiophene, a poly(pyrrole), a polybenzimidazole, a polyethersulfone, a fluorinated ethyl-polypropylene, a perfluoralkoxy, and mixtures thereof, and forming channels in a surface of the polymeric composite layer by direct patterning.

10. The method according to claim 9, wherein the contoured metal base layer and contoured polymeric composite layer are fixed to one another in a roll-to-roll process.

11. The method according to claim 9, wherein the polymeric composite layer is formed on the contoured metal base layer.

12. The method according to claim 9, wherein the contoured metal base layer and the polymeric composite layer are separately formed, and affixed to one another.

13. The fuel cell powered vehicle comprising a fuel cell as claimed in claim 6.

14. The fuel cell powered vehicle as claimed in claim 13, wherein the vehicle comprises a fuel cell powered aircraft.
